(19) United States
(12) Patent Application Publication
(10) Pub. No.: US 2007/0247685 A1
(43) Pub. Date: Oct. 25, 2007

(54) Access Method for Multi-Layer Holographic Recording Medium

(75) Inventors: Takuya Tsukagoshi, Kanagawa (JP); Jiro Yoshinari, Tokyo (JP); Hideaki Miura, Tokyo (JP); Tetsuro Mizushima, Osaka (JP)

Correspondence Address: OLIFF & BERRIDGE, PLC, P.O. BOX 19928, ALEXANDRIA, VA, 22320, US

(73) Assignee: TDK Corporation, Tokyo (JP)

(21) Appl. No.: 10/583,854

(22) PCT Filed: Dec. 6, 2004
(86) PCT No.: PCT/JP04/18164

§ 371 Date: Jun. 21, 2006

(30) Foreign Application Priority Data
Dec. 26, 2003 (JP) 2003-432466

(51) Int. Cl. G03H 1/26

(52) U.S. Cl. 359/22

(57) ABSTRACT

An access method for a multi-layer holographic recording medium which method enables rapid access to the recording position of desired data. In a multi-layer holographic recording medium 16, data pages formed by two-dimensionally arranging a plurality of data blocks for recording data are angle-multiplex-recorded in respective holographic recording layers. In a multi-layer holographic memory reproducing apparatus 10, a data block is accessed based on a layer number assigned to each of the holographic recording layers, a number assigned to each of data pages in each of the holographic recording layers, and a number assigned to each of data blocks in each of the data pages.

### TECHNICAL FIELD

The present invention relates to an access method for a multi-layer holographic recording medium formed by laminating a number of holographic recording layers.

### BACKGROUND ART

Conventionally, a holographic recording medium has been known in which a large amount of data is recorded as holograms.

In this holographic recording medium, a plurality of holograms can be multiplex-recorded in the same recording area in a holographic recording layer. Further, as a recording method for the holographic recording medium, various recording methods have been proposed, such as: an angle multiplex recording method in which a plane wave is employed as a reference beam and the incident angle thereof is gradually changed (see, for example, Japanese Patent Laid-Open Publication No. 2003-337524); and a shift multiplex recording method in which a spherical wave is employed as a reference beam and a recording portion is gradually shifted to perform multiplex recording.

Here, for accessing desired data in such a holographic recording medium, the recording position of the data must first be identified.

However, in a conventional hologram recording medium, there is no effective means for rapidly accessing a recording position of data, and thus a problem exists that data access takes a long time. Particularly in a multi-layer holographic recording medium capable of a large amount of data recording, such a problem tends to emerge, and there is a limit on the speedup of access.

### DISCLOSURE OF THE INVENTION

The present invention has been made to solve the above problems. Accordingly, it is an object of the invention to provide an access method for a multi-layer holographic recording medium which method enables rapid access to the recording position of desired data.

The inventor of the present invention has conducted intensive studies and consequently found that an access method for a multi-layer holographic recording medium which method enables rapid access to the recording position of desired data.

In summary, the above-described objectives are achieved by the following aspects of the present invention.

(1) An access method for a multi-layer holographic recording medium in which data pages formed by two-dimensionally arranging a plurality of data blocks for recording data are angle-multiplex-recorded in respective holographic recording layers of a multi-layer holographic recording layer formed by laminating a multitude of said holographic recording layers, the access method for the multi-layer holographic recording medium comprising accessing the data blocks based on a layer number assigned to each of the holographic recording layers, a number assigned to each of the data pages in each of the holographic recording layers, and a number assigned to each of the data blocks in each of the data pages.

(2) The access method for a multi-layer holographic recording medium according to (1), wherein the data pages are shift-multiplex-recorded over the entire area of the holographic recording layers.

(3) The access method for a multi-layer holographic recording medium according to (1) or (2), wherein the number assigned to each of the data blocks is identified by a row number and a column number assigned to each of the data blocks in the data pages.

(4) The access method for a multi-layer holographic recording medium according to any one of (1) to (3), wherein the layer number assigned to each of the holographic recording layers is identified by a number assigned to each of two-dimensional optical detectors each of which is provided for a respective one of the holographic recording layers in order to detect the data pages which are angle-multiplex-recorded.

(5) The access method for a multi-layer holographic recording medium according to (4), wherein the two-dimensional optical detectors are constituted by an imaging device having the same two-dimensional pixel arrangement as the pixel arrangement of the data pages and the data pages are read out on a row-by-row basis by means of the imaging device.

(6) The access method for a multi-layer holographic recording medium according to any one of (1) to (5), comprising: a process of simultaneously reading a plurality of the data pages which are angle-multiplex-recorded in the same recording area; and a process of shifting to the recording area to be read out.

(7) The access method for a multi-layer holographic recording medium according to any one of (1) to (6), comprising: a process of successively reading a first data page to a last data page in the holographic recording layer; and a process of changing to the holographic recording layer to be read out.

### BRIEF DESCRIPTION OF THE DRAWINGS

FIG. 1 is an optical system diagram of a multi-layer holographic memory reproducing apparatus to which an access method for a multi-layer holographic recording medium according to an embodiment of the present invention is applied.

FIG. 2 is a block diagram illustrating a display device connected to CCDs in FIG. 1.

FIG. 3 is a schematic cross-sectional view illustrating the surroundings of the multi-layer holographic recording medium in FIG. 1.

FIG. 4 is a perspective view schematically illustrating the manner of shift multiplex recording in the multi-layer holographic recording medium in FIG. 1.

FIG. 5 is a perspective view schematically illustrating the configuration of a data page of the multi-layer holographic recording medium in FIG. 1.

FIG. 6 is a perspective view schematically illustrating the configuration of a data block of the multi-layer holographic recording medium in FIG. 1.

FIG. 7 is a perspective view schematically illustrating the manner of simultaneously reading out data pages in the multi-layer holographic recording medium in FIG. 1.

FIG. 8 is a perspective view schematically illustrating the access method for a multi-layer holographic recording medium according to the embodiment of the present invention.

FIG. 9 is a plan view illustrating an example of image output by means of the multi-layer holographic memory reproducing apparatus in FIG. 1.

FIG. 10 is a perspective view schematically illustrating an access method for a multi-layer holographic recording medium according to another embodiment of the present invention.

### BEST MODE FOR CARRYING OUT THE INVENTION

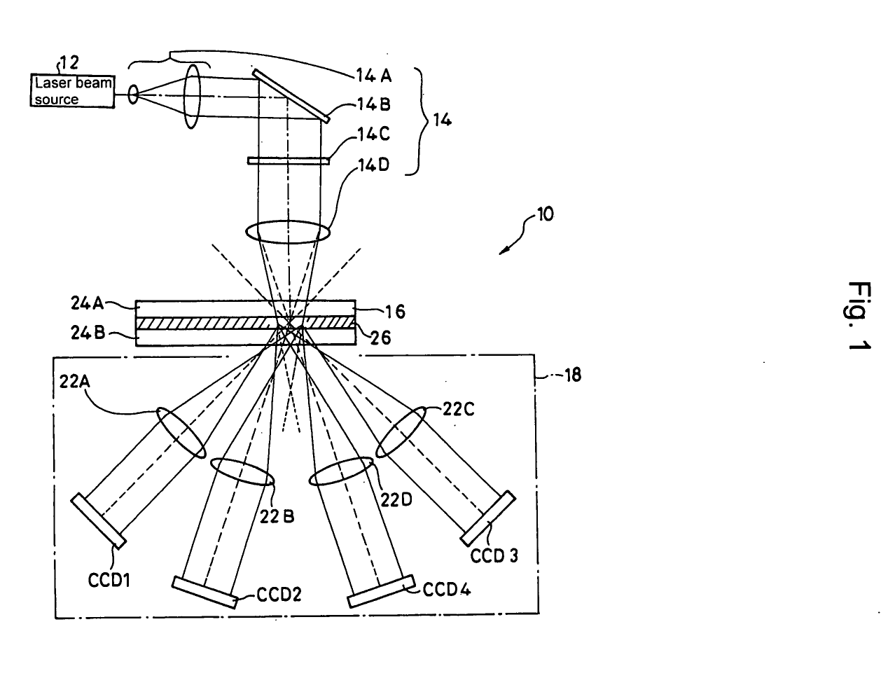

Referring to FIGS. 1 to 7, a description will be given of a multi-layer holographic memory reproducing apparatus 10 to which an access method for a multi-layer holographic recording medium according to an embodiment of the present invention is applied.

This multi-layer holographic memory reproducing apparatus 10 is configured to include: a laser beam source 12; a reproduction laser optical system 14 for guiding a laser beam for reproduction from this laser beam source 12 to a multi-layer holographic recording medium 16; and a detection optical system 18 for reproducing information from a diffraction beam generated by the projection of the laser beam for reproduction onto the multi-layer holographic recording medium 16.

The reproduction laser optical system 14 is configured to include: a beam expander 14A for expanding the beam diameter of the laser beam for reproduction emitted from the laser beam source 12; a mirror 14B which orthogonally reflects the laser beam for reproduction having passed through this beam expander 14A; a phase spatial light modulator 14C on which the laser beam for reproduction having been reflected from the mirror 14B is incident; and a Fourier lens 14D which causes the laser beam for reproduction having passed through the phase spatial light modulator 14C to converge in the multi-layer holographic recording medium 16.

The detection optical system 18 includes four CCD1 to CCD4 (two-dimensional optical detectors) at respective positions each of which is on a line extending the optical axis of an object beam at the time of recording incident on a respective one of holographic recording layers. Further, imaging lenses 22A to 22D are arranged between the multi-layer holographic recording medium 16 and the CCD1 to CCD4, respectively.

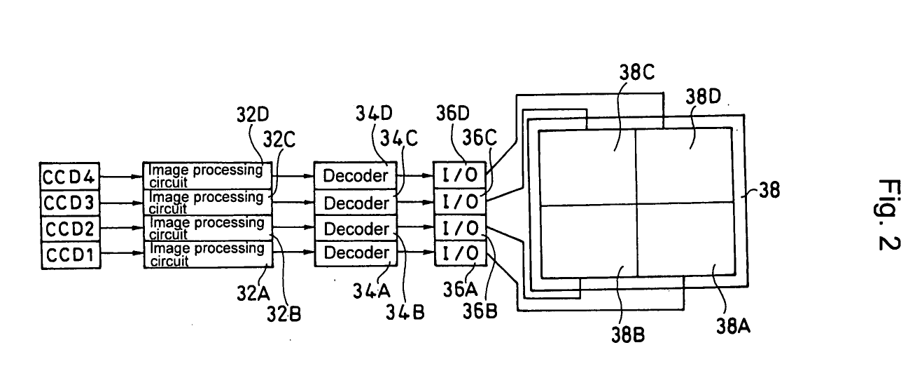

Moreover, as shown in FIG. 2, connected to the CCD1 to CCD4 are display devices 38A to 38D, respectively, via image processing circuits 32A to 32D, decoders 34A to 34D, and input-output devices 36A to 36D, respectively, the four display devices 38A to 38D for the respective CCDs constituting a multi display device 38.

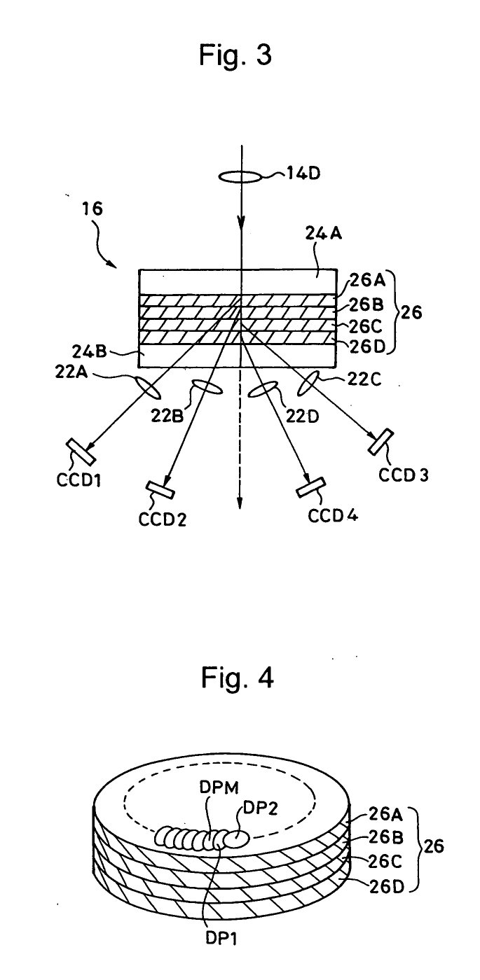

As enlarged in FIG. 3, the multi-layer holographic recording medium 16 is formed by sandwiching a recording layer 26 which is formed by laminating a number of (four layers in this example) holographic recording layers 26A to 26D between a pair of substrates 24A and 24B made of, for example, glass. Further, the CCD1 to CCD4 are provided for the respective holographic recording layers 26A to 26D, and a layer number assigned to each of the holographic recording layers can be identified by the numbers 1 to 4 of the CCD1 to CCD4.

In each of the holographic recording layers 26A to 26D in this recording layer 26, interference fringes of a common reference beam and a respective one of the object beams having different incident angles to the respective holographic recording layers 26A to 26D are angle-multiplex-recorded in a position which is along the surface of a respective one of the layers and the same for all the layers. Further, as shown in FIG. 4, in each of the holographic recording layers 26A to 26D, a plurality of data pages DPm (m=1 to M) are shift-multiplex-recorded over the entire layer. The data pages DPm are numbered from 1 to M, and the numbers 1 to M allow the identification of a data page DPm in each of the holographic recording layers 26A to 26D.

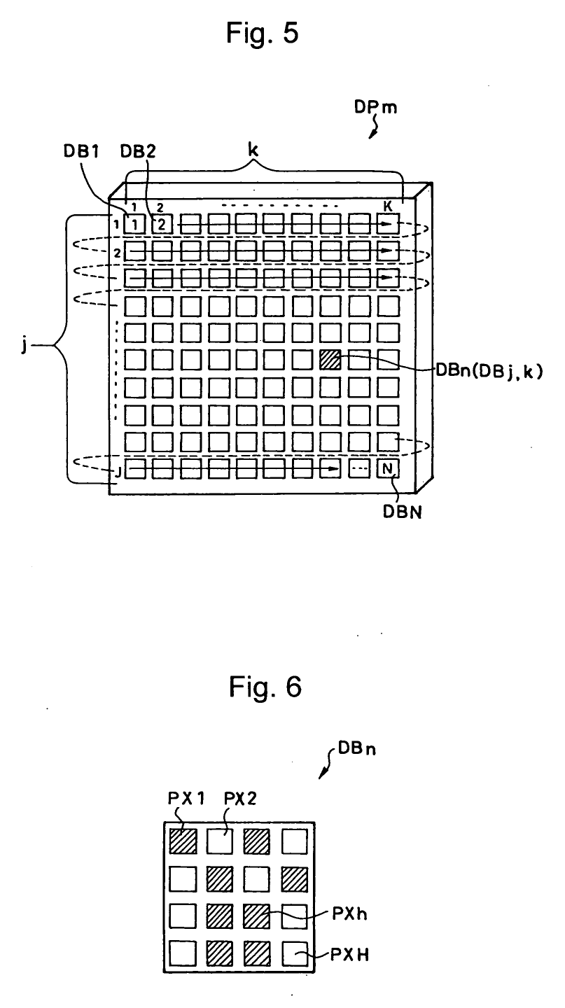

As shown in FIG. 5, each of the data pages DPm is constituted by two-dimensionally arranging a plurality of data blocks DBn (n=1 to N) in which data is recorded. The data blocks DBn are numbered from 1 to N, and the numbers 1 to N allow the identification of a data block DBn in a data page DPm. In addition, a row number j (j=1 to J) and a column number k (k=1 to K) are assigned to each of the data blocks DBn, and this row number j and this column number k also allow the identification of a data block DBj,k in a data page DPm.

Further, the data pages DPm are designed to have the same pixel arrangement as the pixel arrangement of the CCD1 to CCD4. The data pages DPm are read out by the respective CCDs on a row-by-row basis (data in column numbers 1 to K of a row number j serve as one unit).

As shown in FIG. 6, a data block DBn is constituted by a plurality of pixels PXh (h=1 to H), and each of the pixels PXh corresponds to a CCD element constituting the CCD1 to CCD4. Here, in this example, the data block DBn is constituted by 16 pixels and is differentially encoded such that eight among the 16 pixels are ON pixels (bright) and the rest of eight pixels are OFF pixels (dark).

Next, a description will be given of a method for reproducing the data blocks DBn by the multi-layer holographic memory reproducing apparatus 10.

The laser beam for reproduction is converted into a converging beam by the Fourier lens 14D and is incident on the multi-layer holographic recording medium 16. This laser beam for reproduction has the same wavelength as that of the reference beam at the time of recording, and the incident angle thereof to the multi-layer holographic recording medium 16 is also the same as that of the reference beam. Therefore, a diffraction beam is generated in the holographic recording layer 26A in the same direction as that of the object beam. This diffraction beam is received by the CCD1 via the imaging lens 22A, whereby a reproduction image is decoded to obtain reproduction information.

Next, the laser beam for reproduction having passed through the holographic recording layer 26A (a zeroth order diffraction beam) serves as a laser beam for reproduction for the subsequent holographic recording layer 26B, and thus a diffraction beam is also generated therein and is received by the CCD2.

In such a manner, diffraction beams are successively generated also in the holographic recording layers 26C and 26D through a zeroth order diffraction beam from the layer located thereabove and are directed to the CCD3 and CCD4, respectively.

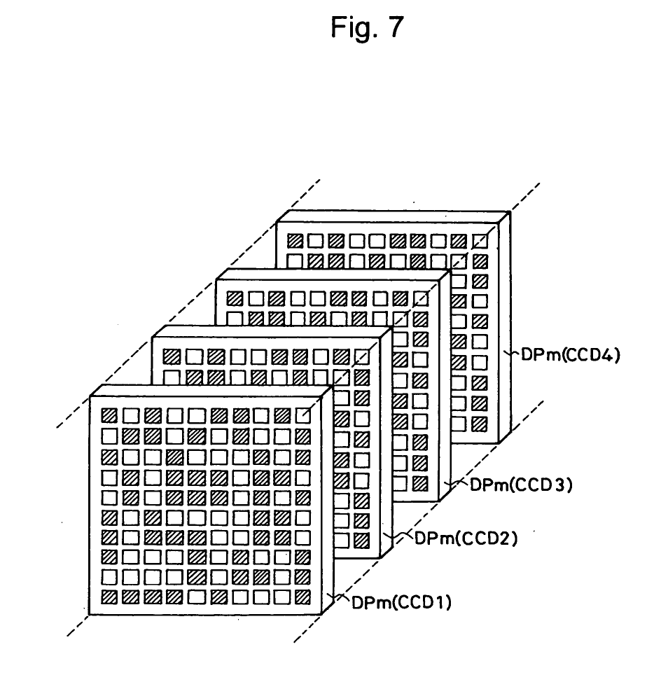

In this embodiment, each of the CCD1 to CCD4 and also each of the imaging lenses 22A to 22D are provided on a line extending the optical path of the object beam at the time of recording, and each of these imaging lenses 22A to 22D constitutes a Fourier lens at the time of recording and an imaging lens system. Therefore, a real image of a spatial light modulator at the time of recording appears on an imaging surface of this imaging lens system. Thus, by arranging the light receiving surface of each of the CCD1 to CCD4 at the imaging surface, a plurality of reproduction images, or the data pages DPm for the CCD1 to CCD4 can be simultaneously detected as shown in FIG. 7.

In addition, the detection of a shift-multiplex-recorded data block DPm is carried out by projecting the reference beam while the multi-layer holographic recording medium 16 in which the holographic recording layers 26A to 26D are formed is rotated by a motor (not shown).

Next, a description will be given of an access method for a data block DBn by the multi-layer holographic memory reproducing apparatus 10.

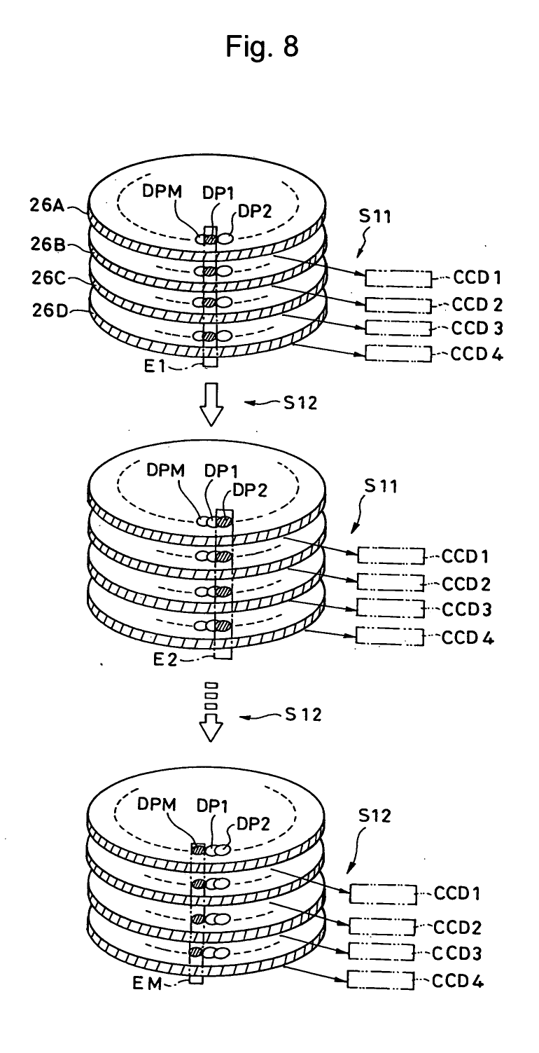

As shown in FIG. 8, in the multi-layer holographic memory reproducing apparatus 10, data blocks DBn on the multi-layer holographic recording medium 16 are accessed by repeating: a process of simultaneously reading out by the CCD1 to CCD4 a plurality of data pages DPm angle-multiplex-recorded in the same recording area Em (m=1 to M) (S11); and a process of shifting to the recording area Em to be read out (S12).

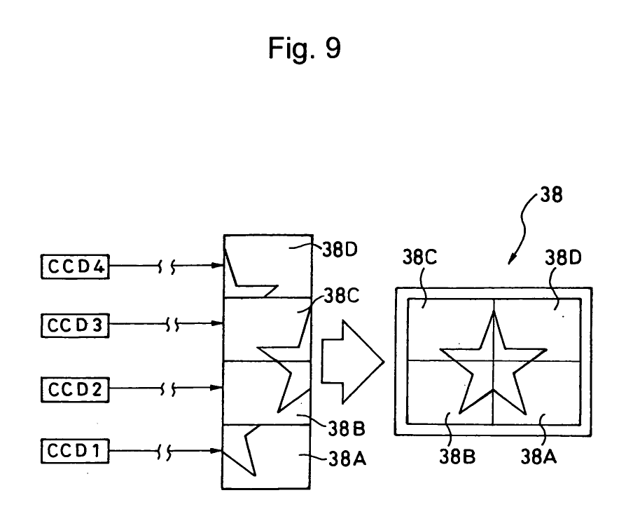

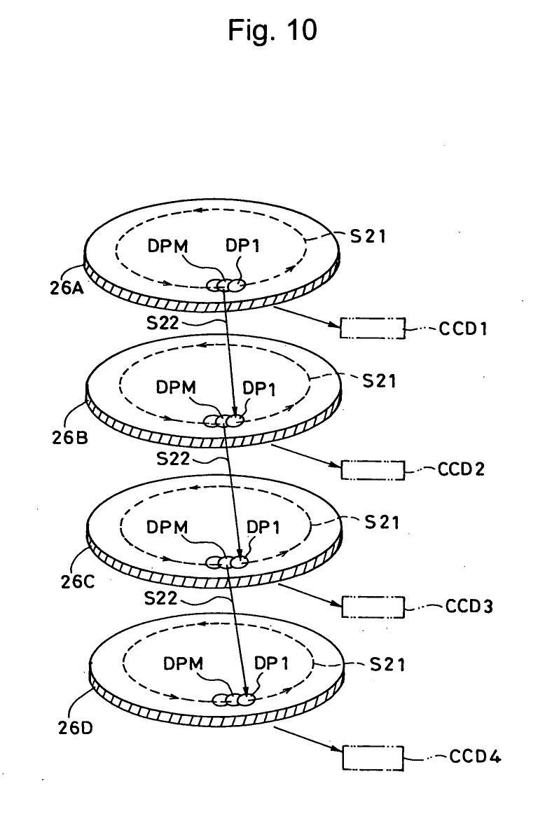

In the multi-layer holographic recording medium 16 of the present embodiment, four split images which are quadrants of one screen are angle-multiplex-recorded. Therefore, the four split images are simultaneously reproduced by repeating the process of simultaneously reading out the four split images by the CCD1 to CCD4 and the process of shifting to the recording area Em to be read out. Consequently, as shown in FIG. 9, these four split images are outputted to the four display devices 38A to 38D, and a large-screen high-definition image formed by combining these four split images is displayed on the multi-display device 38.

Moreover, the access to a data block DBn as mentioned above is carried out based on the layer number assigned to each of the holographic recording layers 26A to 26D and identified by the CCD numbers 1 to 4, the number m (m=1 to M) assigned to each of the data pages DPm in each of these holographic recording layers 26A to 26D, and the number n (n=1 to N) assigned to each of the data blocks DBn in each of these data pages DPm.

Further, in the present embodiment, the access can also be carried out based on, instead of the number n (n=1 to N) assigned to each of the data blocks DBn, the row number j (j=1 to J) and the column number k (k=1 to K) assigned to each of the data blocks DBj,k in each of the data pages DPm.

According to the access method for the multi-layer holographic recording medium 16 according to the embodiment of the present invention, rapid access to the recording position of desired data can be achieved since a data block DBn can be accessed based on the layer number assigned to each of the holographic recording layers 26A to 26D and identified by the numbers 1 to 4 of the CCDs (the two-dimensional detectors), the number m (m=1 to M) assigned to each of the data pages DPm in each of these holographic recording layers 26A to 26D, and the number n (n=1 to N) assigned to each of the data blocks DBn in each of these data pages DPm.

Particularly, the readout speed (the data transfer rate) of the data blocks DBn can be enhanced since the access to the data blocks DBn is carried out through the process of simultaneously reading out by the CCD1 to CCD4 the data pages DPm angle-multiplex-recorded in the same recording area Em (m=1 to M) (S11) and the process of shifting to the recording area Em to be read out (S12).

Moreover, since the data pages DPm are read out by the CCD1 to CCD4 on a row-by-row basis, the access method can serve as a readout method most suitable for a general CCD.

The access method for a multi-layer holographic recording medium according to the present invention is not limited to the access method in the abovementioned embodiment. For example, a plurality of identical images may be angle-multiplex-recorded in the multi-layer holographic recording medium 16, and the identical images may be simultaneously reproduced.

Further, if the readout speed of the data blocks DBn is not necessarily enhanced to a large extent, the data blocks DBn may be accessed through a process of successively reproducing the first data page DP1 to the last data page DPM in a holographic recording layer (S21) and a process of changing to a holographic recording layer to be read out (S22), as shown in FIG. 8.

Such an access method is particularly effective when information recorded in a multi-layer holographic recording medium is sequentially read out (for example, when the entire recorded information is copied for backup).

In the above embodiment, the layer number assigned to each of the holographic recording layers 26A to 26D is identified by the number assigned to each of the CCD1 to CCD4, but the present invention is not limited thereto. For example, the information of the layer number may be recorded in the multi-layer holographic recording medium 16 itself in advance, and the layer number of a holographic recording layer may be identified based on this information.

Further, although the holographic recording layer is formed of four layers and the four CCDs are provided, the present invention is not limited thereto. The holographic recording layer may be formed of two or three layers or five or more layers.

Moreover, in the multi-layer holographic recording medium 16, the data pages DPm are shift-multiplex-recorded over the entire area in the holographic recording layers 26A to 26D, but the present invention is not limited thereto. For example, the data pages DPm may be recorded in only a part of the holographic recording layers 26A to 26D.

Further, the two-dimensional detector in the present invention is not limited to a CCD. Also, the data pages DPm are read out on a row-by-row basis by the CCD1 to CCD4, but the present invention is not limited thereto.

Accordingly, the access method for a multi-layer holographic recording medium according to the present invention is an access method for a multi-layer holographic recording medium in which data pages formed by two-dimensionally arranging a plurality of data blocks for recording data are angle-multiplex-recorded in respective holographic recording layers of the multi-layer holographic recording layer formed by laminating a multitude of the holographic recording layers. The access method is designed such that the data blocks are accessed based on a layer number assigned to each of the holographic recording layers, a number assigned to each of the data pages in each of the holographic recording layers, and a number assigned to each of the data blocks in each of the data pages.

### INDUSTRIAL APPLICABILITY

According to the access method for a multi-layer holographic recording medium according to the present invention, an excellent effect is obtained which enables rapid access to the recording position of desired data.

1. An access method for a multi-layer holographic recording medium in which data pages formed by two-dimensionally arranging a plurality of data blocks for recording data are angle-multiplex-recorded in respective holographic recording layers of a multi-layer holographic recording layer formed by laminating a multitude of said holographic recording layers, the access method for the multi-layer holographic recording medium comprising accessing the data blocks based on a layer number assigned to each of the holographic recording layers, a number assigned to each of the data pages in each of the holographic recording layers, and a number assigned to each of the data blocks in each of the data pages.

2. The access method for a multi-layer holographic recording medium according to claim 1, wherein the data pages are shift-multiplex-recorded over the entire area of the holographic recording layers.

3. The access method for a multi-layer holographic recording medium according to claim 1, wherein the number assigned to each of the data blocks is identified by a row number and a column number assigned to each of the data blocks in the data pages.

4. The access method for a multi-layer holographic recording medium according to claim 2, wherein the number assigned to each of the data blocks is identified by a row number and a column number assigned to each of the data blocks in the data pages.

5. The access method for a multi-layer holographic recording medium according to claim 1, wherein the layer number assigned to each of the holographic recording layers is identified by a number assigned to each of two-dimensional optical detectors each of which is provided for a respective one of the holographic recording layers in order to detect the data pages which are angle-multiplex-recorded.

6. The access method for a multi-layer holographic recording medium according to claim 5, wherein the two-dimensional optical detectors are constituted by an imaging device having the same two-dimensional pixel arrangement as the pixel arrangement of the data pages and the data pages are read out on a row-by-row basis by means of the imaging device.

7. The access method for a multi-layer holographic recording medium according to claim 1, comprising: a process of simultaneously reading a plurality of the data pages which are angle-multiplex-recorded in the same recording area; and a process of shifting to the recording area to be read out.

8. The access method for a multi-layer holographic recording medium according to claim 5, comprising: a process of simultaneously reading a plurality of the data pages which are angle-multiplex-recorded in the same recording area; and a process of shifting to the recording area to be read out.

9. The access method for a multi-layer holographic recording medium according to claim 6, comprising: a process of simultaneously reading a plurality of the data pages which are angle-multiplex-recorded in the same recording area; and a process of shifting to the recording area to be read out.

10. The access method for a multi-layer holographic recording medium according to claim 1, comprising: a process of successively reading a first data page to a last data page in the holographic recording layer; and a process of changing to the holographic recording layer to be read out.

11. The access method for a multi-layer holographic recording medium according to claim 5, comprising: a process of successively reading a first data page to a last data page in the holographic recording layer; and a process of changing to the holographic recording layer to be read out.

12. The access method for a multi-layer holographic recording medium according to claim 6, comprising: a process of successively reading a first data page to a last data page in the holographic recording layer; and a process of changing to the holographic recording layer to be read out.

13. The access method for a multi-layer holographic recording medium according to claim 2, wherein the layer number assigned to each of the holographic recording layers is identified by a number assigned to each of two-dimensional optical detectors each of which is provided for a respective one of the holographic recording layers in order to detect the data pages which are angle-multiplex-recorded.

14. The access method for a multi-layer holographic recording medium according to claim 3, wherein the layer number assigned to each of the holographic recording layers is identified by a number assigned to each of two-dimensional optical detectors each of which is provided for a respective one of the holographic recording layers in order to detect the data pages which are angle-multiplex-recorded.

15. The access method for a multi-layer holographic recording medium according to claim 4, wherein the layer number assigned to each of the holographic recording layers is identified by a number assigned to each of two-dimensional optical detectors each of which is provided for a respective one of the holographic recording layers in order to detect the data pages which are angle-multiplex-recorded.

16. The access method for a multi-layer holographic recording medium according to claim 2, comprising: a process of simultaneously reading a plurality of the data pages which are angle-multiplex-recorded in the same recording area; and a process of shifting to the recording area to be read out.

17. The access method for a multi-layer holographic recording medium according to claim 3, comprising: a process of simultaneously reading a plurality of the data pages which are angle-multiplex-recorded in the same recording area; and a process of shifting to the recording area to be read out.

18. The access method for a multi-layer holographic recording medium according to claim 4, comprising: a process of simultaneously reading a plurality of the data pages which are angle-multiplex-recorded in the same recording area; and a process of shifting to the recording area to be read out.

19. The access method for a multi-layer holographic recording medium according to claim 2, comprising: a process of successively reading a first data page to a last data page in the holographic recording layer; and a process of changing to the holographic recording layer to be read out.

20. The access method for a multi-layer holographic recording medium according to claim 3, comprising: a process of successively reading a first data page to a last data page in the holographic recording layer; and a process of changing to the holographic recording layer to be read out.
